(19) United States
(12) Patent Application Publication
(10) Pub. No.: US 2004/0226095 A1
(43) Pub. Date: Nov. 18, 2004

(54) Sling for emergency transport of a person

(75) Inventors: Radja Lohse, Bethel, MN (US); David Larson, Stanchfield, MN (US); Brian Wildman, Coos Bay, OR (US)

Correspondence Address: BANNER & WITCOFF, LTD., TEN SOUTH WACKER DRIVE, SUITE 3000, CHICAGO, IL, 60606, US

(73) Assignee: Home Hospital Equipment Company, Clarinda, IA

(21) Appl. No.: 10/803,734

(22) Filed: Mar. 18, 2004

Related U.S. Application Data
(60) Provisional application No. 60/471,222, filed on May 16, 2003.

(51) Int. Cl. A61G 1/013

(52) U.S. Cl. 5/627; 5/628

(57) ABSTRACT

A sling for emergency transport of an individual comprises a blanket with straps at the head end for dragging the sling and elevating the head of a person within the sling. Additional straps are provided to retain the person within the sling and to facilitate transport of the person by means of the sling.

### CROSS REFERENCE TO RELATED APPLICATION

This is a utility application based upon and incorporating provisional application Ser. No. 60/471,222 filed May 16, 2003 entitled “Patient Lift Sling Construction” incorporated herewith by reference and for which priority is claimed.

### BACKGROUND OF THE INVENTION

The use of fabric slings or supports for transport of persons in an emergency situation is suggested in various prior art references. For example, in U.S. Pat. No. 6,073,280 entitled “Rescue and Invalid Support Belt”, there is disclosed a belt with handles. The belt fits about the torso of an individual and belt handles are provided for gripping and support of the individual by the belt.

Fabric slings are also used for the transport of invalids. Often such slings are used in combination with hoists, for example, as depicted in U.S. Pat. No. 4,712,257 entitled “Invalid Hoists”. Slings of this nature are also disclosed, for example, in U.S. Pat. No. 4,742,588 entitled “Lifting Sling”.

While such slings are useful for their intended purpose, there are emergency situations wherein the transport of a person in a prone position is necessary. For example, in fire and rescue situations, smoke and heat tend to rise, thus resulting in the desirability to be prone. Further, since persons who are injured may be prone on the floor of a facility, the movement of such a person constitutes a challenging circumstance, particularly if the prone individual is heavier than the person or persons associated with the rescue party. Thus, there has developed the need for a sling construction which is useful, particularly in emergency rescue circumstances.

### SUMMARY OF THE INVENTION

Briefly, the present invention comprises a sling for emergency transport of a person, particularly an individual in a prone position. The sling is comprised of a flexible fabric material such as canvas or the like in the form of a blanket having a top end and a bottom end with a longitudinal axis between the ends. The sling is symmetric about the longitudinal axis and the region below the top end is designed to wrap around an individual in a prone position. Buckles or belts are provided to maintain the sling wrapped around the prone individual. The top end of the sling employs a narrowed, head support section to which a U-shaped strap is attached. A cross strap between the legs of the U-shaped strap provide for supplemental support for the head of a person resting in a prone position with the head at the top end of the sling. The strap may be used to drag or pull the person within the sling thereby enabling movement of the person and rescue even though the person might be heavy, unconscious, or otherwise difficult to move. Sliding movement associated with the sling enables more efficient transport of the person being rescued. Optional handgrip straps are provided on the sides of the outside face of the sling and at the bottom of the sling to further facilitate the transport or movement of an individual within the sling.

An additional strap associated with the bottom or foot end of the sling may be folded over and engaged to facilitate retention of the individual within the sling and to ensure that the feet of the individual in the sling will not catch on some object or item and thereby inhibit the movement of the sling.

Thus it is an object of the invention to provide a sling construction which enables movement of an injured or incapacitated individual by one other person.

It is a further object of the invention to provide compact, inexpensive, and easily usable sling for transport of an individual.

Another object of the invention is to provide a personal transport sling which includes a means for protecting the head as well as the feet of the individual being transported.

It is another object of the invention to provide an improved sling for emergency transport of an individual.

It is a further object of the invention to provide a sling for emergency transport wherein the sling is designed to maintain the head of the individual in an elevated and open condition for access, for breathing and for care by a rescuer.

Another object of the invention is to provide a sling for emergency transport of a person wherein the sling may be folded into a compact form for transport and storage.

Another object of the invention is to provide a sling for emergency circumstances which is easy to use, rugged, efficient, economic, and which enables transport of individuals who are larger and/or heavier than the rescuer.

These and other objects, advantages and features of the invention will be set forth in the detailed description which follows.

### BRIEF DESCRIPTION OF THE DRAWING

In the detailed description of the invention, reference will be made to the drawing comprised of the following figures:

FIG. 1 is a plan view of an embodiment of the sling of the invention;

FIG. 2 is a plan view of the sling of FIG. 1 as viewed from the back side thereof;

FIG. 3 is a plan view of the sling of FIG. 1 in the folded or encapsulated condition;

FIG. 4 is an isometric view of the sling of FIG. 1 wherein an individual is encapsulated therein and a further single individual is in position to transport the sling and incapacitated person;

FIG. 5 is a plan view of the outside face of an embodiment of the sling of the invention depicting the arrangement of auxiliary straps that enable use of the sling as a stretcher;

FIG. 6 is an isometric view of the sling of FIG. 5 depicting the support of a person by the sling; and

FIG. 7 is a side isometric view of the sling of FIG. 6 further depicting auxiliary side straps enabling use of the sling as a stretcher.

### DESCRIPTION OF THE PREFERRED EMBODIMENT

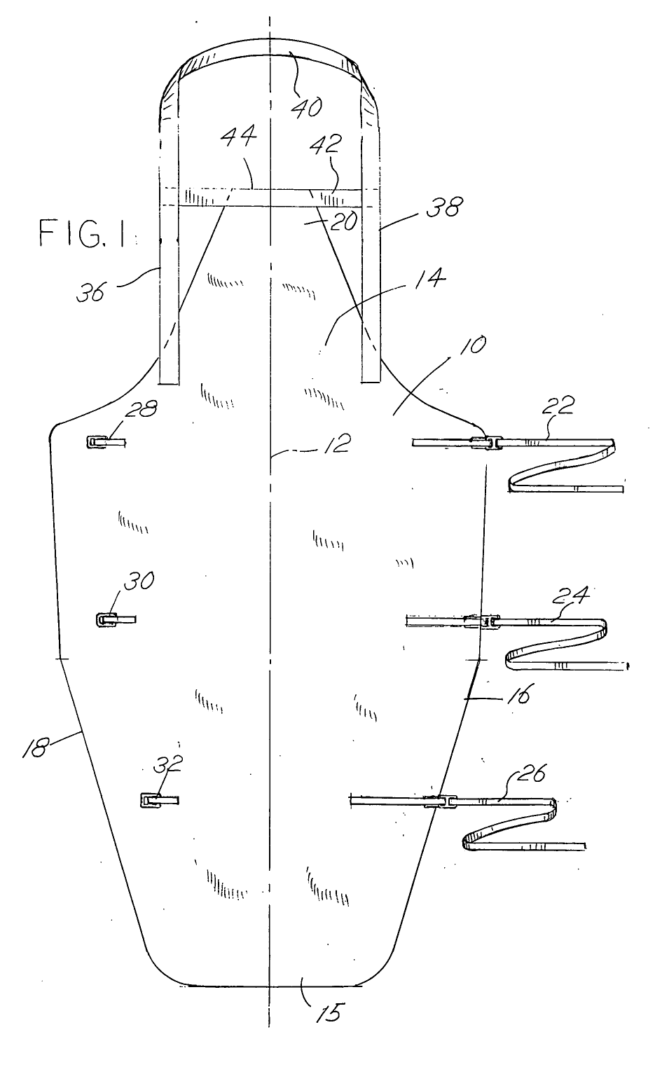

Referring to FIGS. 1-4, the sling of the invention includes a flexible, elongate pad 10 having a longitudinal axis 12 extending from a top end 14 to a bottom end 15. The pad further includes lateral side edges 16 and 18 which are generally equally spaced from the opposite sides of the axis 12. The pad 10 is thus generally symmetrical about the axis 12. However, other configurations of the pad 10 are possible to accomplish the function of the pad 10. The function of the pad 10 is to provide a flexible, yet padded item which can be folded over upon itself so as to encapsulate and retain and safely hold an individual for transport by means of operation of the sling. Thus, the symmetry about the axis 12, though desirable, is not an absolute necessity in order to accomplish the functionality of the invention.

The pad further includes a top or head end 20. The head end 20 comprises an extension integral with the pad 10 at the top end 14 of the pad 10.

A series of three transverse straps 22, 24, 26, 28, 30, 32 are provided. The straps 22, 24, 26, 28, 30, 32 are connectable one to the other so as to hold and retain an individual within the pad 10 as depicted, for example, in FIG. 4. Preferably, pairs of straps 22, 28 and 24, 30 and 26, 32 are connectable and adjustable so as to retain an individual within the pad 10. However, the straps may be crossed or otherwise connected one to the other in order to effect appropriate tension. In the embodiment depicted, three sets of straps are depicted; however, this is not a limiting feature of the invention. Various numbers of straps and their orientation for connection may be altered to achieve the required goal.

FIG. 1 depicts the back side or outside of the pad. The edges 16, 18 fold over about the centerline axis 12 to encapsulate a person as depicted in FIG. 4. The sling further includes a first longitudinal drag strap 36 and a second longitudinal drag strap 38 extending at the top end 14 adjacent to the head section 20. The drag straps 36, 38 in the preferred embodiment are connected by a loop section 40 so that the straps 36, 38 form a continuous single strap. It is strongly preferred that the straps 36, 38 be equal distance from the axis 12 so as to facilitate ease of movement of an individual retained within the pad 10.

A transverse cross strap 42 connects the drag straps 36, 38 and also connects to the very top edge of the head section 20, namely to top edge 44. As depicted in FIG. 4, this will enable support of the head of a person in an elevated position as the person is being transported by means of the sling.

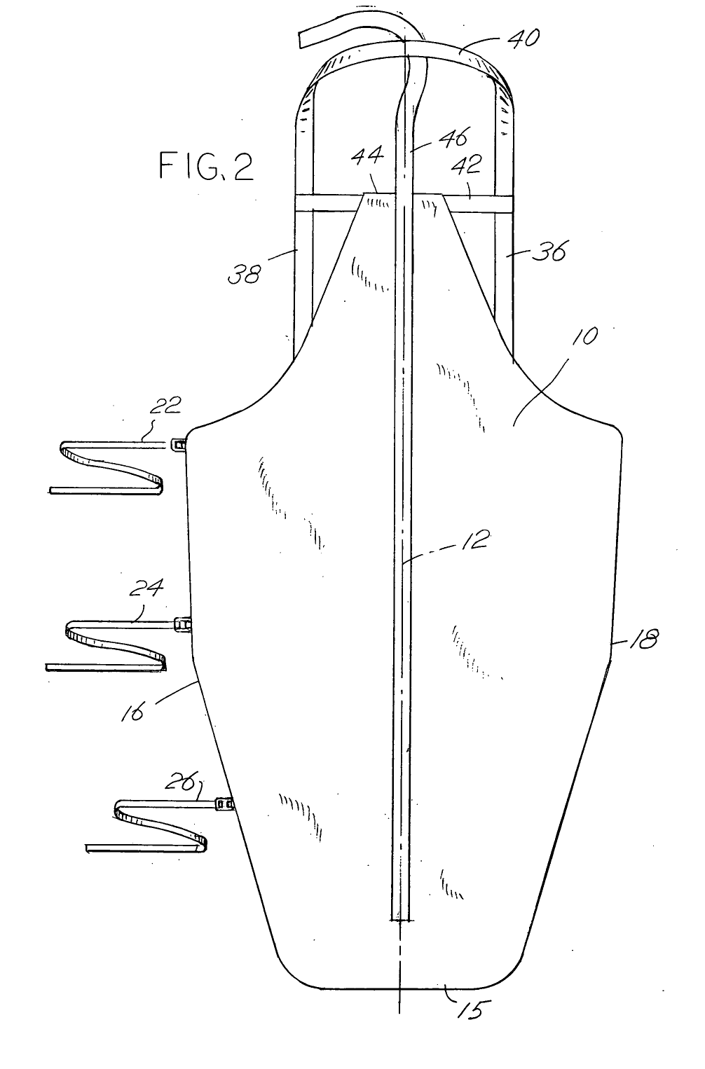

As depicted in FIG. 2, a foot strap 46 is positioned on the inside of pad 10. Strap 46 can be engaged and pulled to facilitate elevation of the feet of an individual retained within the pad 10, particularly in the event that individual is being lowered down a stairway, for example.

Thus, the strap 46 which is a longitudinal strap aligned with the axis 12 is fastened to or at the foot end 15 so that the foot end 15 may be partially elevated by gripping and pulling on the strap 46.

As depicted in FIG. 4 an individual may be encapsulated or retained within the pad 10 by engagement of the transverse straps. The loop 40 may then be placed around the waist of an individual. The foot strap 46 may be pulled to elevate the feet of an individual. The drag straps 36, 38 along with the transverse strap 42 will serve to elevate the head of an individual within the pad 10. A person then seeking to move someone within the pad 10 can move by backing or by moving forward. Thus a person moving the incapacitated individual may arrange himself or herself in any one of a number of positions in order to facilitate movement.

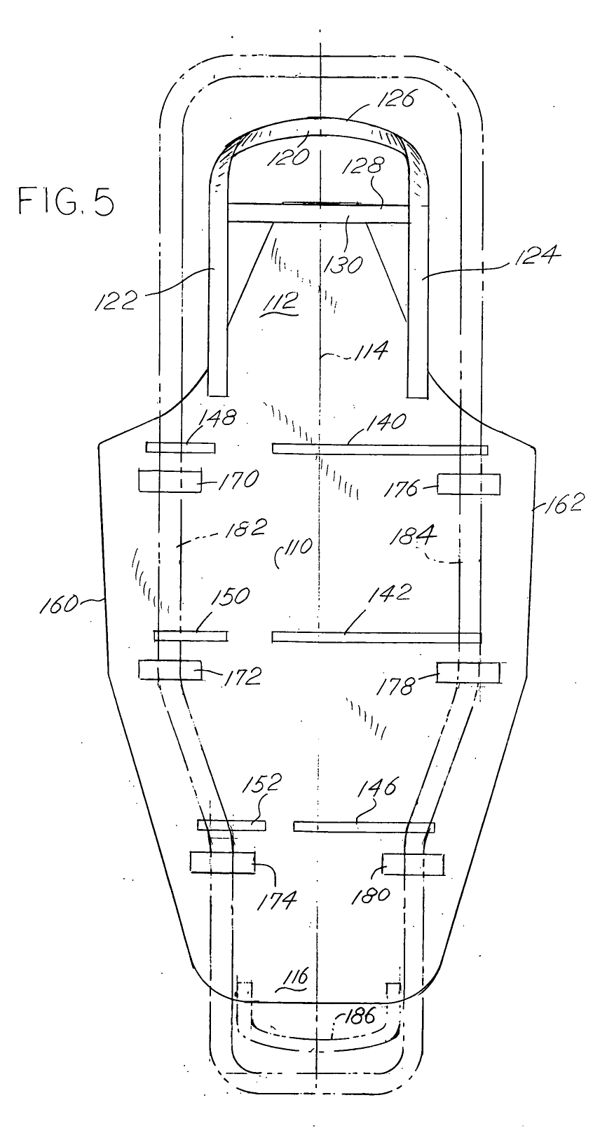

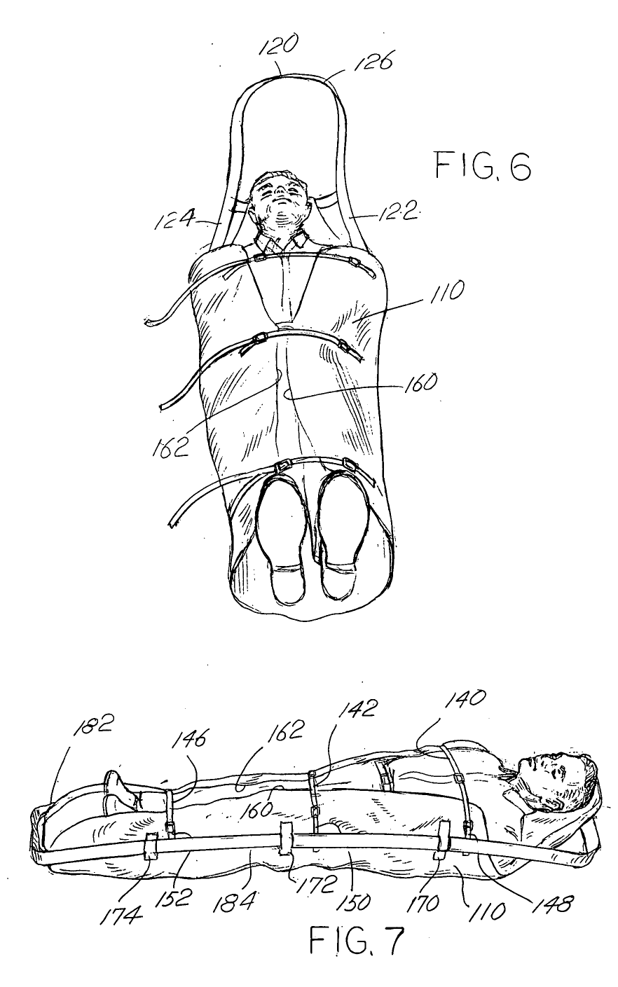

Referring to FIGS. 5-7, the sling embodiment depicted is comprised of a flexible blanket material such as canvas or reinforced plasticized fabric 110. The fabric or blanket 110 includes a longitudinal axis 114 extending between a top end 112 and a bottom end 116. The blanket 110 is generally symmetric with respect to the center line axis 114 and includes an outside face as depicted in FIG. 5 and an inside face. The blanket 110 has the preferred profile depicted in FIG. 5. That is, the head end or top end 112 is narrower than the portion below the top or head end 112. This enables a person who is placed prone of the blanket to maintain their head in an exposed condition during emergency transport.

Thus, the top or head end 112 includes a narrow or neck section which, in the embodiment depicted, has a generally frustoconical configuration. The head end or top end 112 dimensionally has a longitudinal extent in the range of 12-24 inches. The portion below the head end or top end 112 is dimensionally in the range of 60 to approximately 85 inches at its widest extent. The length of the blanket in the direction of the longitudinal axis 114 is in the range of 8-10 feet in the preferred embodiment.

Various straps and buckles are provided to facilitate the utilization of the blanket 110. More specifically, a U-shaped strap 120 having a first lateral leg 122 is generally parallel to the axis 114, is spaced from a second leg 124 and is connected by a crown 126. The legs 122 and 124 are thus generally parallel to one another and positioned on opposite sides of the axis 114 approximately 20-24 inches from one another at top end 112. A transverse strap 128 connects the legs 122 and 124 and is also attached to the extreme top end margin 130 of the top end 112. Note that the legs 122 and 124 are preferably parallel to one another and that the cross strap 128 is generally transverse to the axis 114. The crown 126 which connects the legs 122 and 124 is typically a continuous extension of the legs 122 and 124.

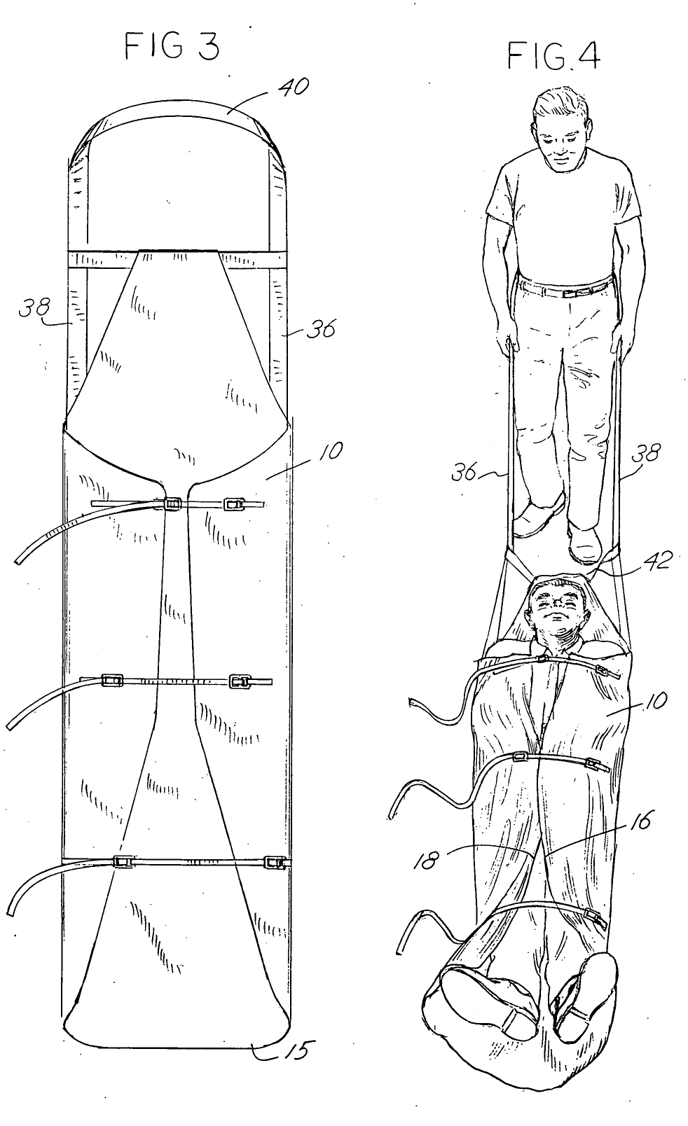

Positioned at discrete intervals on the outside and along the length of the body portion of the blanket 110 below the head end 112 are a series of retention straps 140, 142 and 146 which cooperate with buckles 148, 150 and 152, respectively. As depicted in FIGS. 2 and 3, the straps 140, 142 and 146 may be joined to connect the opposite sides 160 and 162 of the blanket 110 to thereby generally encircle a person lying prone within the blanket 110. Additional auxiliary straps 170, 172 and 174 are arranged at intervals along the longitudinal axis on one side of the axis 114. Similar auxiliary straps 176, 178 and 180 are arranged at intervals in opposed relation to the straps 170, 172, and 174, respectively. An elongate, flexible band 180 may be fitted through the straps 170, 172 and 174. Similarly, an elongate band 182 can be fitted through the straps 176, 178 and 180. The bands 182 and 184 may be joined together or may be incorporated as a single, closed loop band with respect to the sling. The purpose of the bands 182, 184 is discussed hereinafter.

At the bottom end 116 of the blanket 110 is an additional hand strap 186. The hand strap 186 is optional.

In use, an individual in need of rescue and transport is placed in a prone position on the inside face of the blanket 110 with their head at the top end 112 between the legs 122 and 124 of the U-shaped strap 120. The buckle 148 and strap 140 (by way of example) are then joined together to tightly retain the person within the blanket 110. Multiple straps and buckles are depicted and may be utilized to retain the person within the sling.

The rescuer may then grab onto the U-shaped top end strap 120 thereby elevating the head of the person who is being dragged along a floor, for example. In this manner, the rescuer will protect the head of the person being rescued and keep the head elevated as is typically preferred. The person rescued can be dragged along a planar surface or moved along steps in which event the head will be maintained in the elevated position. Supplemental straps at the lower end 116 may be gripped by a second rescuer to facilitate movement of a person retained within the blanket 110.

The lateral or side straps 182 and 184 may form a support for utilization of the sling as a stretcher for a person retained within the sling. That is, by grabbing the joined ends of the straps 182 and 184, the rescuer will, in essence, be providing a stretcher for the person within the sling.

In sum, a person may be strapped within the blanket 110 and moved by a single individual pulling on the strap 120 at the head end 112 while maintaining the head of the individual within the sling in an elevated position. Two individuals may be involved in a rescue operation by using the strap 120 at the head end and the strap 186 at the bottom end. Further, the sling may be utilized in the manner of a stretcher by virtue of the elongate lateral or side straps 182 and 184 which support the lateral or sides of the sling in the position where the sling is enshrouding an individual.

There are various other arrangements of straps, buckles and auxiliary straps that may be utilized in the combination comprising the invention. Additionally, the particular configuration of the blanket 10 may be altered without departing from the spirit and scope of the invention. The invention is therefore limited only by the following claims and equivalents thereof.

What is claimed is:

1. A sling for emergency transport of a person comprising, in combination:
an elongate, flexible material blanket having a top end, a bottom end, a longitudinal axis extending from the top end to the bottom end, an outside face and an inside face, said longitudinal axis generally defining a mid line, said blanket having a symmetric configuration on the opposite sides of the longitudinal axis between the top end and the bottom end, said blanket having a greater width portion below the top end, said blanket having said outside face including a plurality of fastening members in aligned array on the opposite sides of the axis, said top end comprising a lesser width section having opposite lateral sides without fastening members, an elongate strap connecting the opposite lateral sides of the top end and forming a means for pulling the sling while maintaining support of the head of a person positioned on the inside face of the top end.

2. The sling of claim 1 wherein the blanket has a generally uniform width below the top end, said blanket being foldable over a person on the inside face.

3. The sling of claim 1 further including an auxiliary strap affixed to the bottom end for retaining the bottom end folded at least partially toward the top end.

4. The sling of claim 1 further including at least one handgrip strap on the outside face.

5. The sling of claim 1 further including a plurality of handgrip straps on the outside face arrayed in pairs on opposite sides of the longitudinal axis.

6. The sling of claim 1 wherein the elongate strap at the top end has a U-shaped configuration with first and second spaced legs connected by a crown, said legs each being attached to the top end at an equal distance from the axis.

7. The sling of claim 6 further including a connecting support strap transverse to the axis connecting the legs of the elongate strap, said elongate strap and support strap attached to the outside face of the sling.

8. The sling of claim 1 further including first and a second attachment members attached respectively to the outside face of the blanket and extending longitudinally from the bottom end to the top end, said first and second attachment member each spaced from the axis to provide a side support for the sling for use as a stretcher.

9. The sling of claim 8 wherein the attachment members each comprise an elongate strap.

10. A personnel transport sling comprising, in combination:
a flexible pad having a longitudinal central line axis, a top end, a bottom end and opposite side edges, said pad being generally symmetrical about the axis and sized to generally encapsulate a person by folding about the edges toward each other about the axis, said top end including a projecting head support section;
a first set of transverse fasteners for retaining the opposite edges in a folded condition;
a second set of drag straps extending generally parallel to the axis, at least one strap for extending from each side at the top end for gripping to drag the sling and contents thereof; and
a cross strap extending between drag straps, said cross strap attached to the head support section to effect elevation thereof upon elevation of the drag straps.

11. The sling of claim 10 further including an axial strap extending from the bottom end for folding over and supporting the bottom end upon dragging of the sling.

12. The sling of claim 10 including a plurality of transverse straps spaced axially.
